(19) United States
(12) Patent Application Publication
(10) Pub. No.: US 2025/0144639 A1
(43) Pub. Date: May 8, 2025

(54) SHREDDER

(71) Applicant: SEIKO EPSON CORPORATION, Tokyo (JP)

(72) Inventor: Kohei KOZAKI, Shiojiri (JP)

(21) Appl. No.: 18/932,692

(22) Filed: Oct. 31, 2024

(30) Foreign Application Priority Data
Nov. 2, 2023 (JP) 2023-188260

(51) Int. Cl. B02C 18/00

(52) U.S. Cl. CPC B02C 18/0007

(57) ABSTRACT

A shredder includes: a shredding section that shreds paper into shredded pieces; a waste box that stores the shredded pieces; a holding section that includes a bottom plate portion on which the waste box is mounted; and a weight measurement section that is disposed under the bottom plate portion and measures a weight of the shredded pieces accumulated in the waste box, in which the weight measurement section measures the weight of the shredded pieces together with a weight of the bottom plate portion and a weight of the waste box.

The present application is based on, and claims priority from JP Application Serial Number 2023-188260, filed Nov. 2, 2023, the disclosure of which is hereby incorporated by reference herein in its entirety.

### BACKGROUND

### 1. Technical Field

The present disclosure relates to a shredder.

### 2. Related Art

Hitherto, a shredder that shreds unnecessary printed copy paper and the like has been known. For example, JP-A-2004-8965 discloses a shredder including a device that levels and compresses shredded waste in a waste container.

However, the shredder described in JP-A-2004-8965 has a problem in that it is not possible to know a weight of the shredded waste accumulated in the waste container. In detail, although it is possible to visually estimate a volume of the shredded waste accumulated in the waste container, it is difficult to estimate the weight of the shredded waste from the visually estimated volume when the shredded waste is compressed by a compression function. A shredder that optically detects a volume of shredded waste in a waste container has also been known, but it is often observed that the shredded waste in the waste container is compressed to delay a timing of shredded waste collection. Also in this case, it is difficult to estimate a weight of the shredded waste. To promote effective use of shredded pieces which are the shredded waste, it is important to know an exact weight of the shredded pieces, and thus, there has been a demand for a shredder that measures a weight of shredded pieces.

### SUMMARY

A shredder includes: a shredding section that shreds paper into shredded pieces; a waste box that stores the shredded pieces; a holding section that includes a bottom plate portion on which the waste box is mounted; and a weight measurement section that is disposed under the bottom plate portion and measures a weight of the shredded pieces accumulated in the waste box, in which the weight measurement section measures the weight of the shredded pieces together with a weight of the bottom plate portion and a weight of the waste box.

### BRIEF DESCRIPTION OF THE DRAWINGS

FIG. 1 is a perspective view illustrating an exterior of a shredder according to an embodiment.

FIG. 2 is a perspective view illustrating the exterior of the shredder with a door open.

FIG. 3 is a cross-sectional view illustrating an internal configuration of the shredder.

FIG. 4 is a cross-sectional perspective view illustrating configurations of a shredding section and the like.

FIG. 5 is a perspective view illustrating the shredder in a state in which a waste box is removed.

FIG. 6 is an enlarged cross-sectional view illustrating an arrangement of a weight measurement section, a holding section, and the waste box.

FIG. 7 is a cross-sectional perspective view illustrating an arrangement of the weight measurement section, a bottom plate portion, and the like.

FIG. 8 is a perspective view illustrating configurations of the weight measurement section and the like.

FIG. 9 is a perspective view illustrating a shape of the bottom plate portion.

FIG. 10 is a perspective view illustrating the shape of the bottom plate portion.

FIG. 11 is a cross-sectional perspective view illustrating configurations of a frame member and the bottom plate portion.

FIG. 12 is a cross-sectional perspective view illustrating the configurations of the frame member and the bottom plate portion.

FIG. 13 is a cross-sectional perspective view illustrating the configurations of the frame member and the bottom plate portion.

FIG. 14 is a cross-sectional perspective view illustrating the configurations of the frame member and the bottom plate portion.

FIG. 15 is a perspective view illustrating a shape of a guide surface.

FIG. 16 is an enlarged side view illustrating an arrangement of the guide surface.

FIG. 17 is a cross-sectional view illustrating an arrangement of a protrusion.

### DESCRIPTION OF EMBODIMENTS

In the following embodiment, a shredder 1 that shreds used paper or the like after printing will be described with reference to the drawings. In the following drawings, an X axis, a Y axis, and a Z axis are used as coordinate axes orthogonal to one another, a direction pointed by each arrow is a + direction, and a direction opposite to the + direction is a − direction. When the shredder 1 is installed on a horizontal plane, the Z axis is an imaginary axis along a vertical direction. A +Z direction is an upward direction, and a −Z direction is a downward direction.

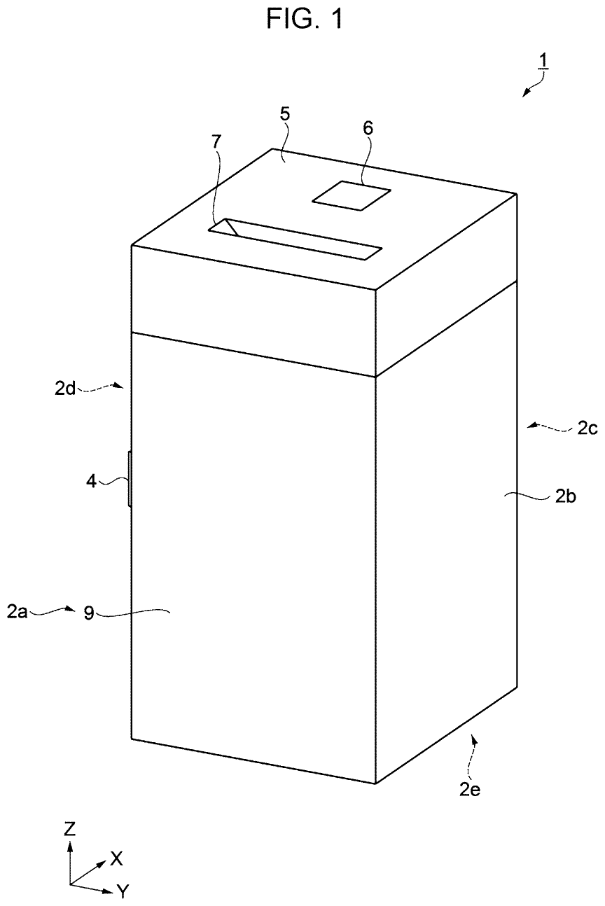

As illustrated in FIG. 1, the shredder 1 according to the present embodiment has a rectangular parallelepiped shape. The shredder 1 includes a housing having a top surface 5 and a bottom surface 2e facing each other in a vertical direction, and four side surfaces 2a, 2b, 2c, and 2d. The side surfaces 2a, 2b, 2c, and 2d each have a rectangular shape with long sides aligned along the Z axis.

Each of components of the shredder 1 described below is housed inside the housing. A user of the shredder 1 shreds paper while facing the side surface 2a facing a −X direction. In the following description, the user of the shredder 1 is simply referred to as the user.

A display unit 6 is disposed in a +X direction on the top surface 5. The display unit 6 displays various types of information regarding the shredder 1, such as an operating status and operation instructions. In particular, the display unit 6 displays a weight of shredded pieces C stored in a waste box 11 described below. The display unit 6 may also serve as an operation unit that receives various instructions from the user for the shredder 1. The display unit 6 is, for example, a touch panel type liquid crystal display device. The display unit 6 is not limited to a configuration that also serves as the operation unit. The operation unit may be installed separately from the display unit 6.

A feed slot 7 is disposed in the −X direction on the top surface 5 and is an opening through which paper to be shredded is inserted. The paper inserted from the feed slot 7 moves by gravity to a shredding section, which is described below, inside the housing.

A door 9 forming a part of the side surface 2a is disposed on the side surface 2a. The door 9 has a substantially rectangular shape when viewed from the −X direction, with long sides aligned along the Z axis. The door 9 is a substantially plate-shaped member. The door 9 can be opened by using the long side in a +Y direction as a fulcrum.

A handle 4 is provided on the long side of the door 9 in a −Y direction. The door 9 can be opened by holding the handle 4 with a hand and pulling the door 9 in a substantially −X direction.

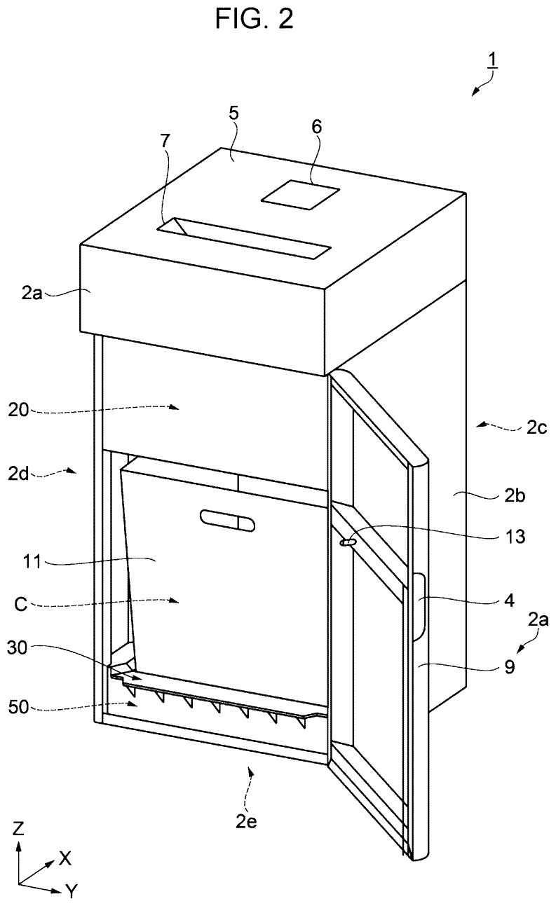

As illustrated in FIG. 2, the shredder 1 includes a shredding section 20, the waste box 11, a holding section 30, and a weight measurement section 50 inside the housing.

The shredding section 20 is disposed on an upper side in the housing of the shredder 1. The shredding section 20 shreds paper into the shredded pieces C. The waste box 11 is disposed in an internal space of the housing below the shredding section 20. The waste box 11 is a box having a substantially rectangular parallelepiped shape with an open top. The shredded pieces C fall from the shredding section 20 due to gravity and are stored in the waste box 11.

The holding section 30 is disposed at a bottom portion of the waste box 11 in such a way as to surround the periphery of the bottom portion. The weight measurement section 50 is disposed directly on the bottom surface 2e and under the waste box 11.

The waste box 11 is attachable to and detachable from the shredder 1. The waste box 11 can be removed by opening the door 9. The user can open the door 9, remove the waste box 11 from the shredder 1, and collect the shredded pieces C from the waste box 11.

A protrusion 13 is disposed on an inner side of the door 9. The protrusion 13 is provided at a position corresponding to an upper side of the waste box 11 when the door 9 is closed. A function of the protrusion 13 is described below.

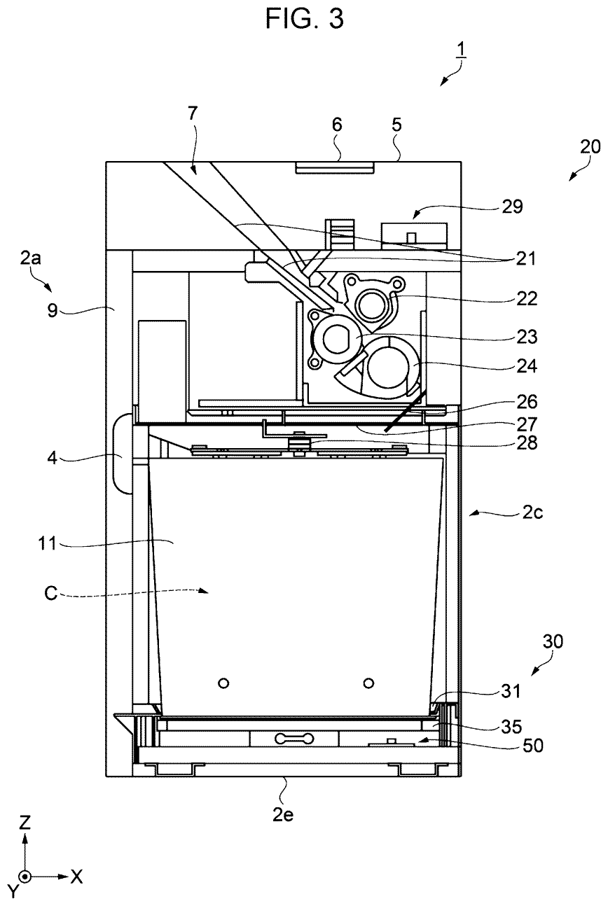

As illustrated in FIG. 3, the shredding section 20 includes a first slope portion 21, a first vertical blade 22, a second vertical blade 23, a horizontal blade 24, a second slope portion 26, a top plate 27, an agitation portion 28, and a control unit 29.

In the shredding section 20, the first slope portion 21, the first vertical blade 22, the second vertical blade 23, the horizontal blade 24, the second slope portion 26, and the control unit 29 are disposed above the top plate 27. The top plate 27 is disposed above the waste box 11, and the agitation portion 28 is disposed between the waste box 11 and the top plate 27. The control unit 29 is disposed above the first vertical blade 22 and the second vertical blade 23, and directly below the top surface 5.

The first slope portion 21 extends from the feed slot 7 toward the first vertical blade 22 and the second vertical blade 23. The first vertical blade 22 and the second vertical blade 23 are disposed downstream of the first slope portion 21. The horizontal blade 24 is disposed downstream of the first vertical blade 22 and the second vertical blade 23. The second slope portion 26 is disposed below the horizontal blade 24.

The paper to be shredded passes through the feed slot 7, the first slope portion 21, the first vertical blade 22, the second vertical blade 23, and the horizontal blade 24 to become the shredded pieces C. The shredded pieces C are guided to the agitation portion 28 by the second slope portion 26.

The control unit 29 is electrically connected to the above-described components of the shredding section 20, the display unit 6, the weight measurement section 50, and the like. The control unit 29 controls an overall operation of the components.

The control unit 29 includes a central processing unit (CPU) and a storage unit including a random access memory (RAM), and a read only memory (ROM). The storage unit stores various programs for controlling the shredder 1. The control unit 29 may include dedicated hardware (application specific integrated circuit (ASIC)) for performing at least some of various steps of processing. The control unit 29 may be configured as a circuit including one or more processors that operate according to a computer program (software), one or more dedicated hardware circuits such as ASICs, or a combination thereof.

The processor includes a CPU and a memory such as a RAM and a ROM. The memory stores program codes or instructions configured to cause the CPU to perform processing. The memory, that is, a computer-readable medium, includes any medium that can be accessed by a general-purpose computer or a special-purpose computer.

Although not illustrated, the shredder 1 includes an optical sensor that detects a volume of the shredded pieces C accumulated in the waste box 11. The optical sensor is disposed facing downward on the top plate 27 and detects a position of an upper surface of the shredded pieces C accumulated in the waste box 11. The optical sensor is electrically connected to the control unit 29. A detection result of the optical sensor is transmitted to the control unit 29 and displayed on the display unit 6 in the same manner as a measurement result of the weight measurement section 50.

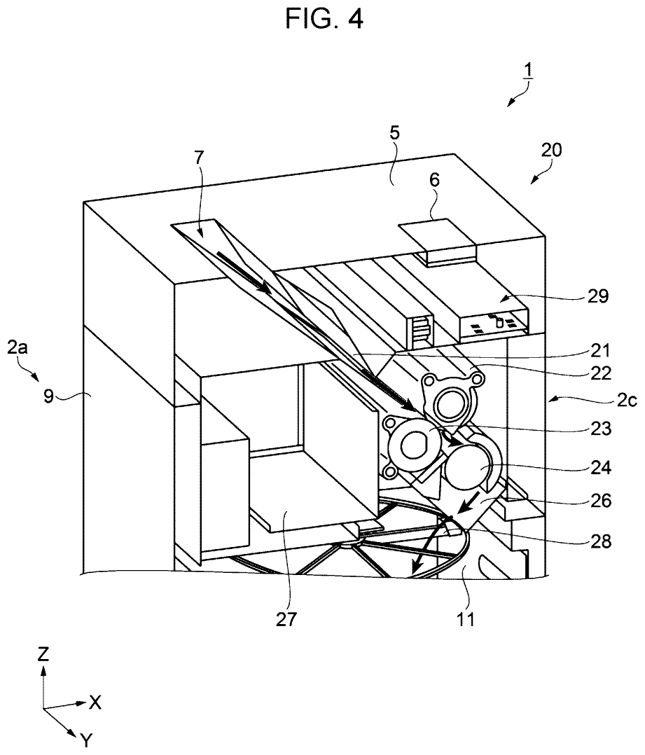

As illustrated in FIG. 4, the feed slot 7 has an elongated rectangle shape along the Y axis. A shape of the feed slot 7 corresponds to, for example, a width dimension of the paper to be shredded. Here, in FIG. 4, arrows indicate a path along which the paper to be shredded becomes the shredded pieces C and reaches the waste box 11. The paper to be shredded is fed from the feed slot 7 to the shredding section 20. The paper slides down along the first slope portion 21 due to gravity and reaches a gap between the first vertical blade 22 and the second vertical blade 23.

The first vertical blade 22 and the second vertical blade 23 form a pair and rotate with the paper held between the first vertical blade 22 and the second vertical blade 23. Each of the first vertical blade 22 and the second vertical blade 23 has a substantially columnar shape, and a height direction of the columnar shape is aligned with the Y axis. Each of the first vertical blade 22 and the second vertical blade 23 rotates around an axis along the Y axis by driving of a drive motor (not illustrated). Each of the first vertical blade 22 and the second vertical blade 23 includes a plurality of blades arranged in a direction along the Y axis. The paper is shredded in a movement direction by the first vertical blade 22 and the second vertical blade 23 into elongated pieces of paper. The pieces of paper are moved to the horizontal blade 24.

The horizontal blade 24 has a substantially columnar shape, and a height direction of the columnar shape is aligned with the Y axis. The horizontal blade 24 rotates around an axis along the Y axis by the driving of the drive motor (not illustrated). The horizontal blade 24 shreds the pieces of paper in a direction intersecting the movement direction of the pieces of paper into the shredded pieces C. The shredded pieces C fall due to gravity and are guided by the second slope portion 26 to the agitation portion 28.

The agitation portion 28 disperses the shredded pieces C that have slid down along the second slope portion 26 into the air and causes the shredded pieces C to fall into the waste box 11. As a result, it is possible to allow the shredded pieces C to be accumulated in the waste box 11 without being concentrated directly below the second slope portion 26.

The agitation portion 28 is a propeller-shaped member. The agitation portion 28 rotates around an axis along the Z axis by the driving of the drive motor (not illustrated). The shredded pieces C are caught up in the rotation of the agitation portion 28 and are dispersed into the air above the waste box 11.

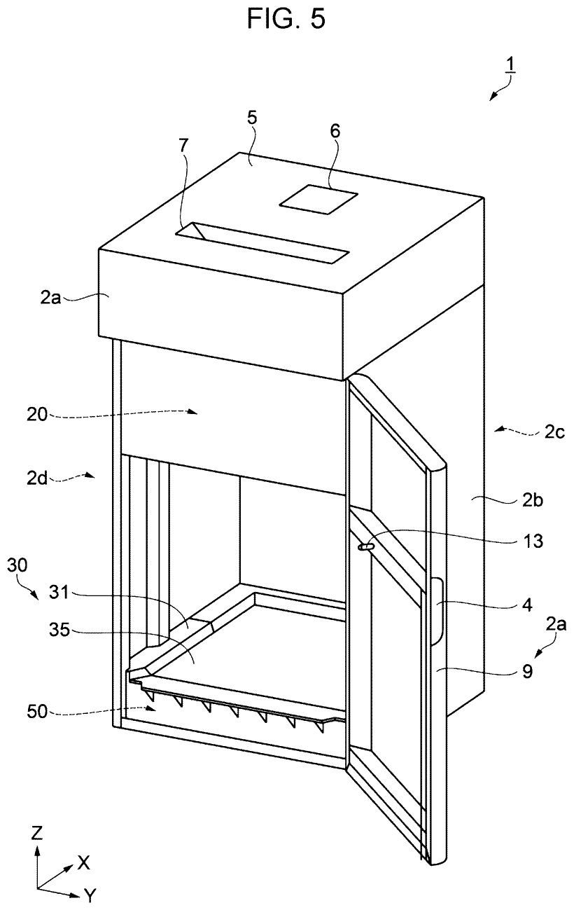

As illustrated in FIG. 5, the holding section 30 includes a frame member 31 and a bottom plate portion 35. When the waste box 11 is removed, the bottom plate portion 35 is exposed. The waste box 11 is mounted on the bottom plate portion 35. The bottom plate portion 35 has a rectangular shape in plan view when viewed from above, and the frame member 31 surrounds the bottom plate portion 35 in a frame shape.

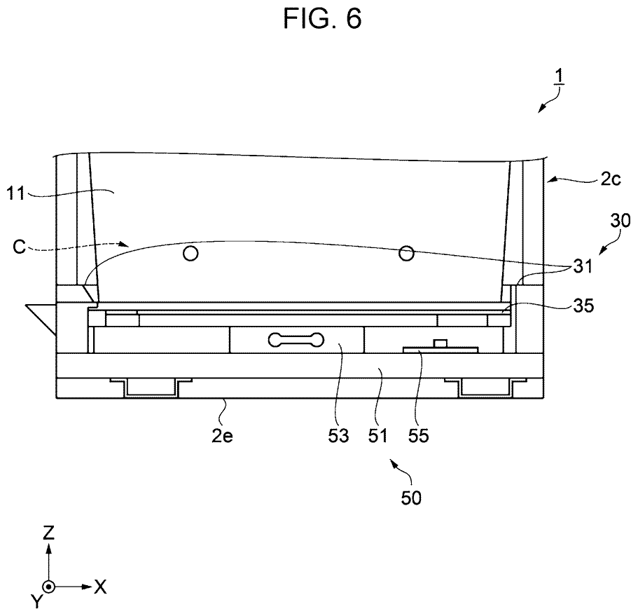

As illustrated in FIG. 6, the weight measurement section 50 is disposed under the bottom plate portion 35. The weight measurement section 50 measures a weight of the shredded pieces C accumulated in the waste box 11. More specifically, in the shredder 1, the weight of the shredded pieces C is measured by the weight measurement section 50, along with a weight of the bottom plate portion 35 and a weight of the waste box 11. The door 9 is not illustrated in FIG. 6.

The weight measurement section 50 includes a base plate portion 51, a load cell 53, and a circuit board 55. The base plate portion 51 supports the load cell 53 and the circuit board 55. The base plate portion 51 extends along the X axis. The base plate portion 51 is, for example, a metal plate subjected to sheet metal working.

The load cell 53 is supported by the base plate portion 51 from below, and the load cell 53 is disposed at the center of the base plate portion 51 in a direction along the X axis. The bottom plate portion 35 is mounted on an upper side of the load cell 53. The load cell 53 measures the weight, which is a magnitude of a load, from a strain caused by the load applied from above. The load cell 53 is, for example, a beam type.

The circuit board 55 is electrically connected to the control unit 29 and a strain gauge (not illustrated) of the load cell 53. The circuit board 55 is disposed in the +X direction with respect to the load cell 53. The circuit board 55 transmits measured weight data of the shredded pieces C to the control unit 29 as an electric signal. The weight data is displayed as the weight of the shredded pieces C on the display unit 6 described above via the control unit 29.

The control unit 29 or the circuit board 55 may store a combined weight of the waste box 11 and the bottom plate portion 35. The weight data may be a combined weight of the shredded pieces C, the waste box 11, and the bottom plate portion 35, or the weight of the shredded pieces C obtained by subtracting weights of the waste box 11 and the bottom plate portion 35 from the combined weight. When the weight data is the combined weight, the weight of the shredded pieces C is calculated by the control unit 29.

A weight measurement mechanism of the weight measurement section 50 is not limited to the load cell 53. Examples of the weight measurement mechanism other than the load cell 53 include a spring scale and an electromagnetic scale.

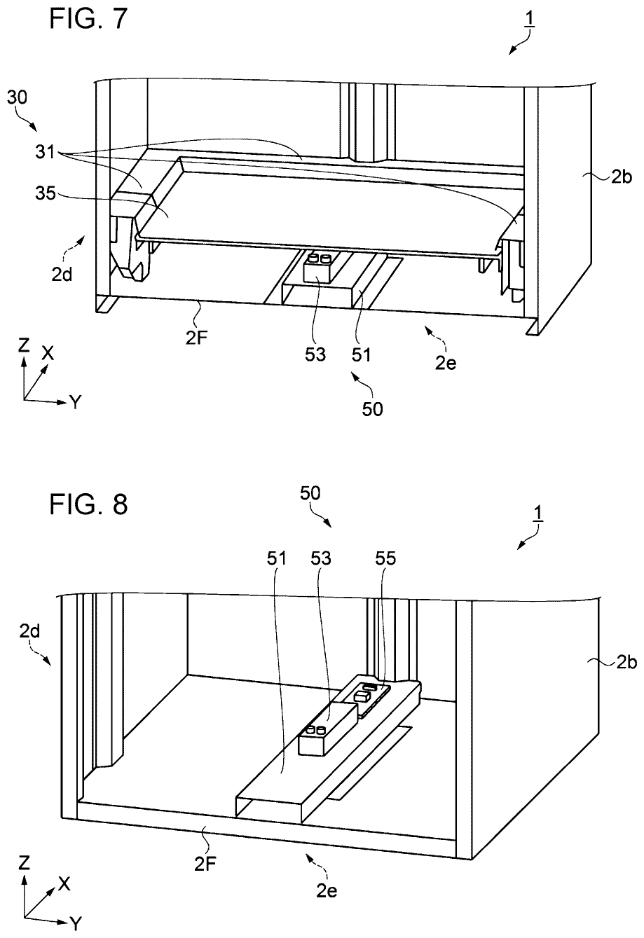

As illustrated in FIGS. 7 and 8, the base plate portion 51 is fixed to a frame portion 2F. The frame portion 2F has a substantially plate-like shape and is a part of a structural member of the shredder 1. A lower surface of the frame portion 2F is the bottom surface 2e.

The base plate portion 51 is formed using, for example, a metal plate subjected to sheet metal working. The base plate portion 51 supports the load cell 53 at a position one step higher than the frame portion 2F.

The bottom plate portion 35 is supported by the load cell 53 from below and is in a floating state above the base plate portion 51 and the frame portion 2F. The load of the waste box 11 and the shredded pieces C mounted on the bottom plate portion 35 is applied only to the load cell 53.

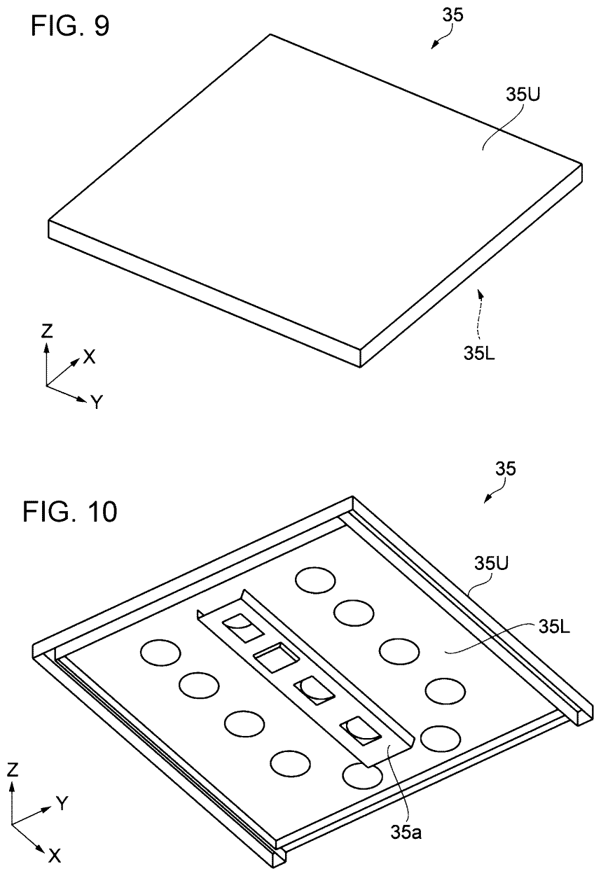

As illustrated in FIGS. 9 and 10, the bottom plate portion 35 has a substantially plate-like shape and has a square shape in plan view when viewed from above. The bottom plate portion 35 includes an upper surface member 35U facing upward and a lower surface member 35L facing downward. The upper surface member 35U has a flat surface on which the waste box 11 is mounted along an X-Y plane. The upper surface member 35U is formed of a resin or the like.

The lower surface member 35L is assembled integrally with the upper surface member 35U. The lower surface member 35L ensures a mechanical strength of the bottom plate portion 35. The lower surface member 35L is formed using, for example, a metal plate subjected to sheet metal working. A support portion 35a is attached to the center of the lower surface member 35L in a direction along the Y axis.

The support portion 35a is a member that comes into contact with the load cell 53 and is positioned when the bottom plate portion 35 is mounted on the load cell 53. The support portion 35a is also formed using, for example, a metal plate subjected to sheet metal working.

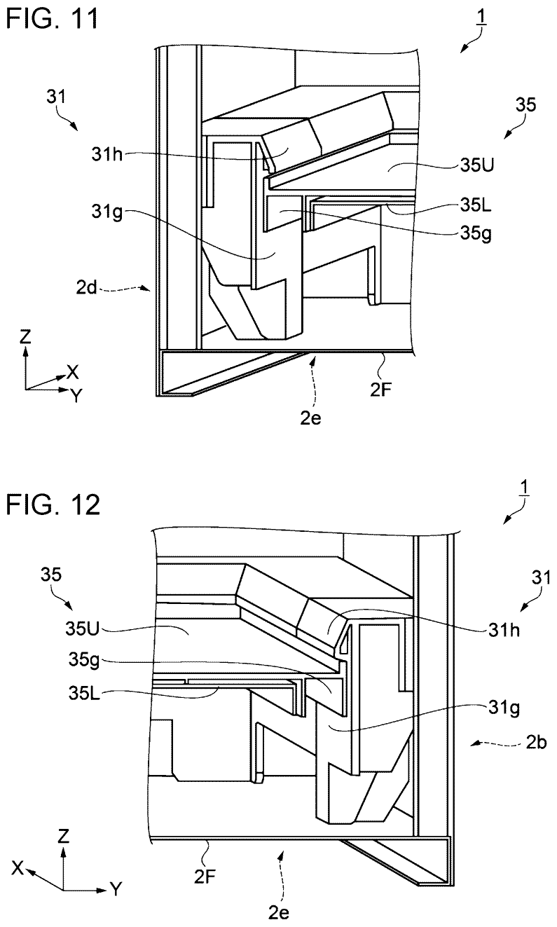

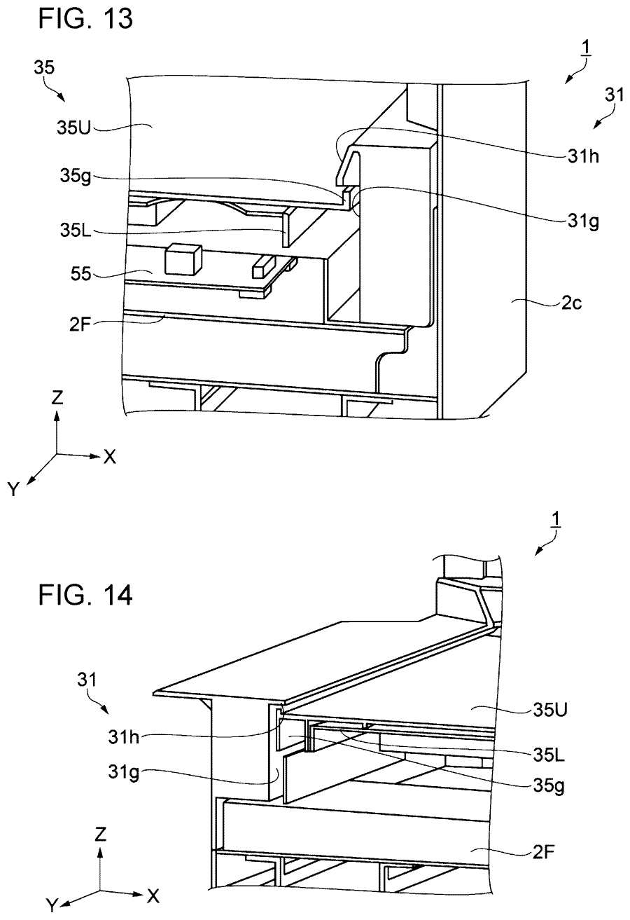

As illustrated in FIGS. 11, 12, 13, and 14, the frame member 31 of the holding section 30 includes a guide portion 31g and a visor portion 31h.

The visor portion 31h is positioned on an inner side of the frame member 31 and is disposed corresponding to four sides of the bottom plate portion 35. An inner edge of the visor portion 31h overlaps an outer edge of the upper surface member 35U of the bottom plate portion 35 in plan view when viewed from above.

Therefore, it becomes difficult for the shredded pieces C that have spilled out of the waste box 11 to enter a space under the bottom plate portion 35. As a result, it is possible to prevent the shredded pieces C from adhering to the load cell 53 and the circuit board 55, thereby preventing malfunctions and breakdowns. In addition, it is possible to reduce the effort required for cleaning and maintenance of the weight measurement section 50. Furthermore, when mounting the waste box 11 on the bottom plate portion 35 after collecting the shredded pieces C from the waste box 11, the visor portion 31h guides a bottom of the waste box 11 to the bottom plate portion 35. Therefore, the waste box 11 can be easily mounted at a predetermined position on the bottom plate portion 35.

The upper surface member 35U of the bottom plate portion 35 includes a bottom plate guide portion 35g. The bottom plate guide portion 35g is disposed along four sides of the outer edge of the upper surface member 35U. The bottom plate guide portion 35g extends along an X-Z plane at two sides along the X axis among the four sides of the outer edge of the upper surface member 35U, and extends along a Y-Z plane at two sides along the Y axis.

The guide portion 31g of the frame member 31 is disposed along four sides of an inner edge of the frame member 31 and corresponds to the bottom plate guide portion 35g. The guide portion 31g extends along the X-Z plane at two sides along the X axis among the four sides of the inner edge of the frame member 31, and extends along the Y-Z plane at two sides along the Y axis. The guide portion 31g and the bottom plate guide portion 35g are disposed to face each other.

The guide portion 31g and the bottom plate guide portion 35g come into contact with each other and slide due to displacement of the bottom plate portion 35. The displacement of the bottom plate portion 35 refers to vertical movement of the bottom plate portion in a situation in which the waste box 11 is mounted on the bottom plate portion 35 or when the shredded pieces C are accumulated in the waste box 11.

In the above-described situation, the guide portion 31g and the bottom plate guide portion 35g come into contact with each other and slide, so that the bottom plate guide portion 35g is guided by the guide portion 31g, and inclination of the bottom plate portion 35 with respect to the horizontal plane is corrected. As a result, the load is evenly distributed on the load cell 53, so that accuracy in measuring the weight of the shredded pieces C is improved.

The bottom plate guide portion 35g also functions as a reinforcing rib when the upper surface member 35U is formed of a resin. The bottom plate guide portion 35g improves a mechanical strength of the upper surface member 35U.

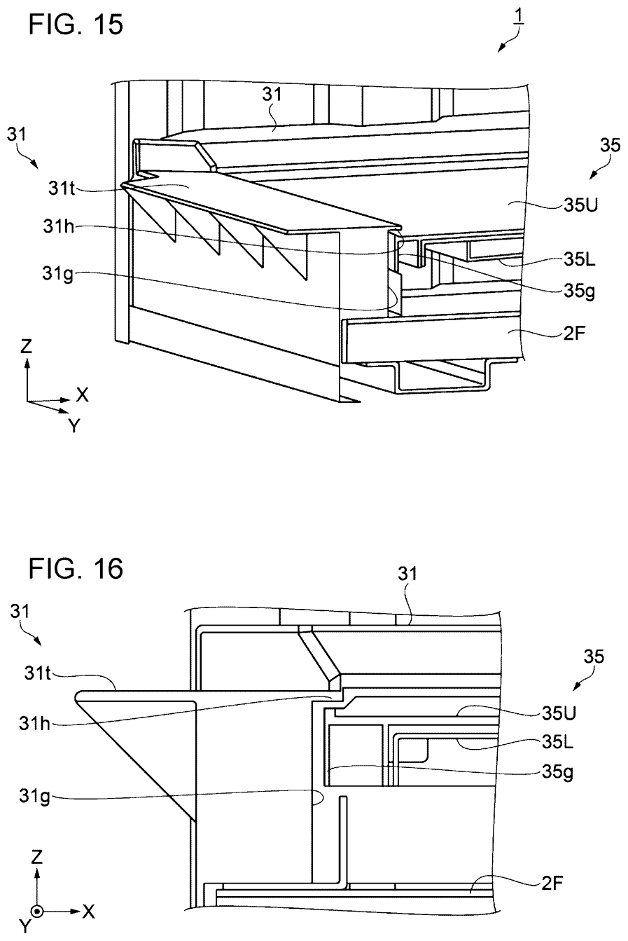

As illustrated in FIG. 15, a shelf-shaped guide surface 31t is provided at a position corresponding to an outer edge of the bottom plate portion 35 in the −X direction in the frame member 31. The guide surface 31t extends along the X-Y plane. When the waste box 11 is attached to or detached from the shredder 1, the bottom of the waste box 11 moves on the guide surface 31t.

As illustrated in FIG. 16, the guide surface 31t is positioned slightly higher than the upper surface member 35U of the bottom plate portion 35 in a direction along the Z axis. When mounting the waste box 11 on the bottom plate portion 35, the waste box 11 can be mounted once on the guide surface 31t and then shifted and mounted on the upper surface member 35U. Compared to a case where the waste box 11 is mounted directly on the upper surface member 35U, an impact on the load cell 53 is mitigated, so that the load cell 53 can be protected.

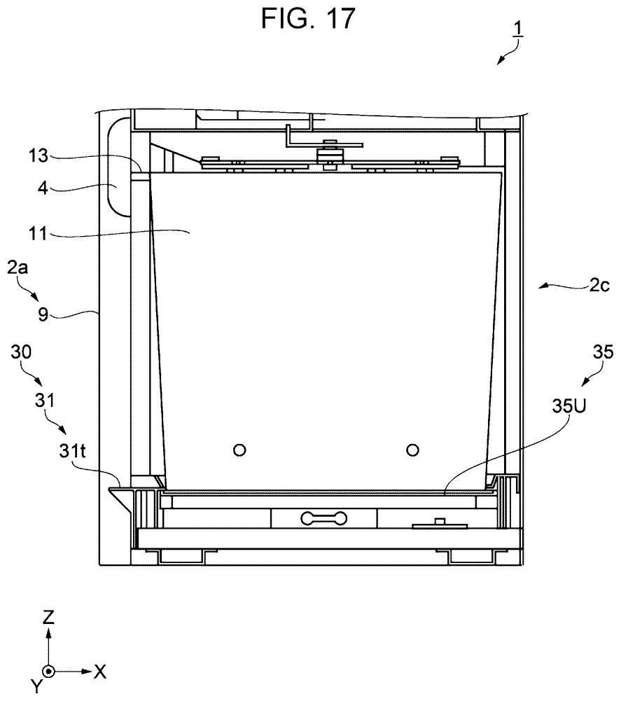

As illustrated in FIG. 17, the protrusion 13 is disposed on the inner side of the door 9. The protrusion 13 protrudes from a back side of the door 9 in the +X direction. A height of the protrusion 13 is approximately equal to a height of an upper end of the waste box 11 in the direction along the Z axis.

The protrusion 13 assists in installing the waste box 11 at a predetermined position when installing the waste box 11 in the shredder 1. Specifically, in some cases, the waste box 11 is not fully inserted inside the shredder 1 and is mounted at a position shifted in the −X direction from a correct position of the upper surface member 35U. In this case, when the door 9 is closed, the protrusion 13 pushes the upper end of the waste box 11 in the +X direction, so that the waste box 11 is pushed and moved to the correct position of the upper surface member 35U. As a result, the waste box 11 is installed correctly, and the weight measurement of the shredded pieces C is performed correctly in the weight measurement section 50.

According to the present embodiment, the following effects can be obtained.

It is possible to measure the weight of the shredded pieces C accumulated in the waste box 11. It is possible to provide the shredder 1 that measures the weight of the shredded pieces C.

It is possible to determine whether or not the waste box 11 is full of the shredded pieces C based on the weight. Therefore, it is not possible to delay a collection timing of the shredded pieces C by pushing and compressing the shredded pieces C. Therefore, compression of the shredded pieces C is avoided. When the shredded pieces C are recycled, the shredded pieces C are not compressed. Therefore, processing and use are made easier, and the quality of recycled goods is improved.

What is claimed is:

1. A shredder comprising:
a shredding section that shreds paper into shredded pieces;
a waste box that stores the shredded pieces;
a holding section that includes a bottom plate portion on which the waste box is mounted; and
a weight measurement section that is disposed under the bottom plate portion and measures a weight of the shredded pieces accumulated in the waste box,
wherein the weight measurement section measures the weight of the shredded pieces together with a weight of the bottom plate portion and a weight of the waste box.

2. The shredder according to claim 1, wherein
the holding section includes a guide portion,
the bottom plate portion includes a bottom plate guide portion, and
the guide portion and the bottom plate guide portion come into contact with each other and slide due to displacement of the bottom plate portion to correct inclination of the bottom plate portion with respect to a horizontal plane.

3. The shredder according to claim 1, wherein
the holding section includes a visor portion, and
an inner edge of the visor portion overlaps an outer edge of the bottom plate portion in plan view when viewed from above.
